(19) United States
(12) Patent Application Publication
(10) Pub. No.: US 2010/0088851 A1
(43) Pub. Date: Apr. 15, 2010

(54) SYSTEM FOR ATTACHING A HINGE ON AN AUTOMOBILE DOOR LEAF

(75) Inventors: Michel Briault, Creteil (FR); Frederic Desmard, Massy (FR); Dominique Erbs-Jory, Ermont (FR); Ludovic Vollet, Neauphle-Le-Chateau (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S., Boulogne Billancourt (FR)

(21) Appl. No.: 12/529,364

(22) PCT Filed: Mar. 4, 2008
(86) PCT No.: PCT/FR08/50365

§ 371 Date: Dec. 17, 2009

(30) Foreign Application Priority Data
Mar. 6, 2007 (FR) 0753654

(51) Int. Cl. E05D 5/02; B21J 15/02

(52) U.S. Cl. 16/252; 29/525.06

(57) ABSTRACT

A system for attaching a hinge on a door leaf of an automobile includes at least two riveted self-punched connections that clamp the hinge and the door leaf.

The invention relates to a system for fixing a hinge on a door leaf of a motor vehicle, and its attachment method.

Usually, the hinges are fixed to the door leaf by screw/type fixing means or by welding.

For example, in the document EP 1347135, two hinges are attached to a trunk lid by screw/nut type fixing means. These fixing means require holes to be made in the trunk lid, which adds a step to the method of assembling the trunk lid and embrittles the latter through susceptibility to corrosion. Furthermore, the appearance of the visible part of the hinge that is attached to the trunk lid is not satisfactory. The mechanical strength of these links is also limited. This solution is therefore unsatisfactory in the context of limiting assembly times and costs on a production line.

The invention aims to improve the system for attaching a hinge to a door leaf of a motor vehicle.

To achieve these objectives, in the context of the present invention, there is provided a system for fixing a hinge on a door leaf of a motor vehicle comprising at least two riveted self-punched links that clamp the hinge and the door leaf.

According to other characteristics of the invention, the door leaf is a trunk lid.

According to other characteristics of the invention, the riveted self-punched links clamp three stacked elements, a pivoting support for the hinge, a liner for the trunk lid and a reinforcing piece for the trunk lid.

Also provided for in the context of the invention is a method of attaching a hinge on a door leaf of a motor vehicle, the hinge comprising a pivoting support, the door leaf comprising at least two elements, characterized in that the pivoting support, the first element and the second element of the door leaf, in that order, are stacked on a preformed support structure, and at least two riveted self-punched links are implemented on the second element so as to clamp the pivoting support and the two elements.

According to other characteristics of the invention, the method is characterized in that the door leaf is a trunk lid comprising a liner, a reinforcing piece and in that the hinge, the liner and the reinforcing piece, in that order, are stacked on a preformed support structure, and at least two riveted self-punched links are implemented on the reinforcing piece so as to clamp the pivoting support, the liner and the reinforcing piece.

According to other characteristics of the invention, the method is characterized in that three non-aligned riveted self-punched links are implemented.

Other characteristics, aims and advantages of the present invention will become apparent on reading the detailed description given below, and in light of the appended drawings, given by way of nonlimiting example.

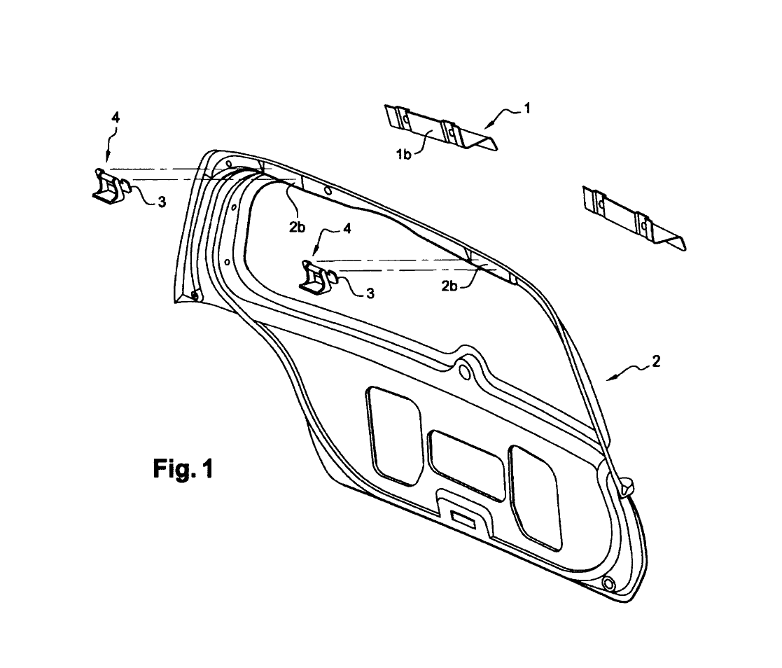

FIG. 1 is a perspective view of two hinges to be attached to a trunk lid according to the invention.

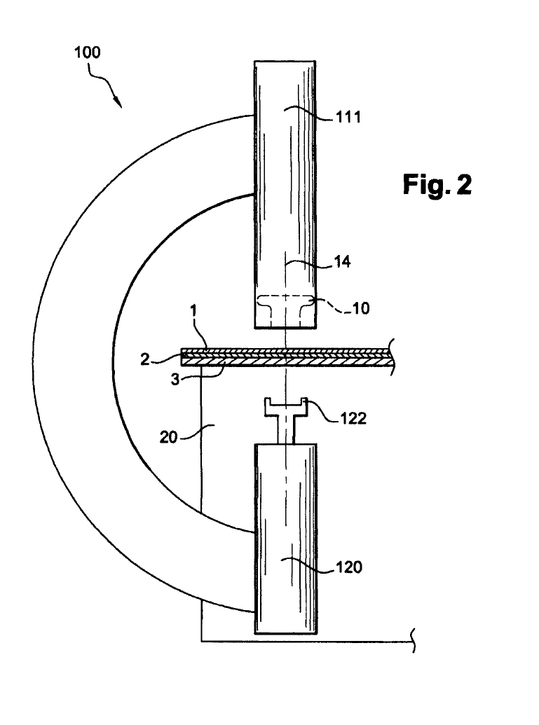

FIG. 2 represents a diagrammatic view of an appliance for implementing the method according to the invention.

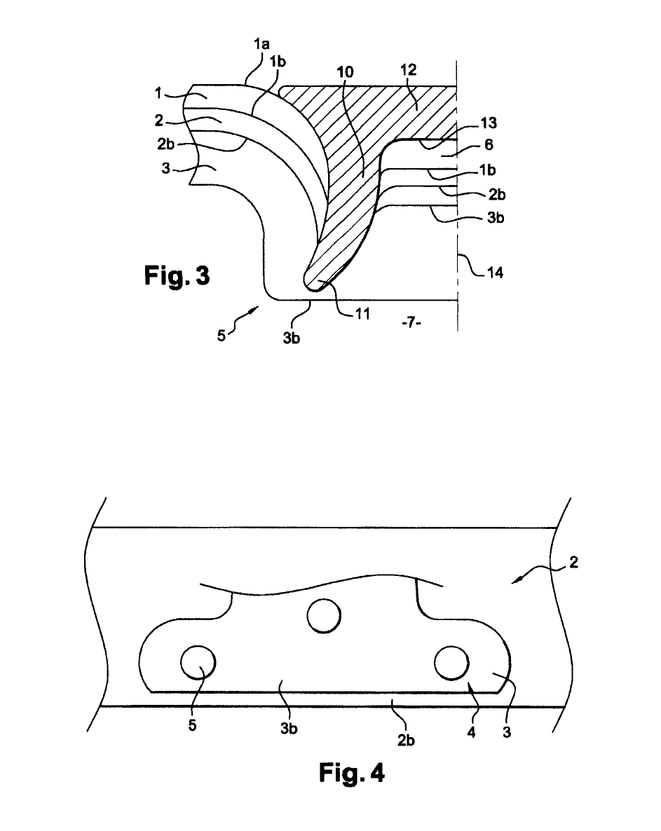

FIG. 3 represents a half-view in axial cross section of a riveted self-punched link according to the invention.

FIG. 4 represents a diagrammatic view of a hinge comprising riveted self-punched links according to the invention.

To produce a system for attaching a hinge 4 on a door leaf 8 of a motor vehicle according to the invention, the hinge 4 and at least two elements 1, 2 of the door leaf 8 are stacked then fixed by self-punching rivets.

As FIG. 1 shows, the trunk lid 8 comprises at least one reinforcing piece 1 and a liner 2. Each of the two hinges 4 comprises a pivoting support 3 suitable for fixing to the trunk lid 8.

In order to carry out the riveting, an appliance 100 and a support structure 20 that are specially adapted to this operation, as represented in FIG. 2, are used.

This appliance 100 is curved, forming a C in order to improve accessibility to the areas to be riveted. It comprises in particular a bottom portion 120 and a top portion 111.

The top portion is an actuator 111 for distributing rivets 10. The actuator 111 can be hydraulic or electrical. The actuator 111 and the rivets 10 can have a cylindrical shape with circular section. The rivets 10 have an axis 14 of revolution.

The bottom portion 120 comprises at its free end an imprint or a snap 120, for example with circular section, located in the extension of the actuator 111.

During riveting, the axes of the actuator 111 and of the snap 122 are arranged coaxially to the axis 14 of the rivet 10 either side of the parts 1, 2, 3 to be riveted.

The support structure 20 can include rests (not represented) for geometrically retaining the various parts 1, 2, 3 during the method.

The bottom part (not represented) of the support structure 20 can be dimensioned so that it can cooperate with the bottom portion 120 to allow for the self-centering of the riveted links. For example, the bottom portion can include voids enabling the bottom portion 120 to be fitted so that the appliance 100 can be geometrically placed relative to the hinge and to the trunk lid 8. The positioning of the appliance 100 is therefore simplified to produce the riveted links.

The top part (not represented) of the support structure 20 can be dimensioned so that it can receive the hinge 4 and the different elements 1, 2, 3 of the trunk lid 8 to respect their geometrical positioning relative to each other.

In the method of fixing the hinge 4 to the trunk lid 8, the bottom face 3b of the pivoting support 3, the bottom face 2b of the liner 2 and the bottom face 1b of the reinforcing piece 1, in that order, are stacked on the preformed support structure 20. The stacking of these parts 1, 2, 3 is done so as to make them substantially parallel. Then, at least two riveted self-punched links are produced on the reinforcing piece 1 so as to clamp the hinge 4 and the door leaf 8, more particularly the pivoting support 3, the liner 2 and the reinforcing piece 1.

At least two riveted self-punched links are produced but, in order to understand this invention, a single riveted self-punched link will be described with FIG. 3.

As represented in FIG. 3, the pivoting support 3, the liner 2 and the reinforcing piece 1 are thus clamped by a self-punching rivet 10. This rivet 10 comprises a foot 11 of hollow cylindrical form and a head 12. The head 12 has a bottom wall 13 oriented toward the foot 11 and substantially parallel to the top face 1a of the reinforcing piece 1 and to the bottom face 3b of the pivoting support 3.

After the riveting, the rivet 10 still has a form that is substantially symmetrical in revolution with axis 14.

In the riveted link comprising the reinforcing piece 1, between the bottom wall 13 of the head 12 of the rivet 10 and the top face 1a, a void area 6 is provided in the embodiment described and represented in FIG. 3. Nevertheless, depending on the dimensions of the rivet and the thicknesses of the parts 1, 2, 3 to be assembled, the void area 6 can be larger or smaller or not even exist.

The head 12 of the rivet 10 is pressed into the reinforcing piece 1 so that the external surface of the head 12 is in the extension of the top face 1a and thus constitutes a substantially flat surface with the top wall 1a of the reinforcing piece 1. When the self-punching rivet 10 is put in place, the latter penetrates into the part located on top of the parts 1, 2, 3 to be assembled, namely the reinforcing piece 1 in FIGS. 2 and 3, the foot 11 of the rivet 10 is deformed while being crushed laterally and provokes a deformation of the parts 1, 2, 3 to be assembled, in particular a deformation of the bottom face 3a of the pivoting support 3. More particularly, the deformation of the self-punching rivet 10 provokes the formation of a bead, the foot 11 being flared in the part situated below the stack of the parts 1, 2, 3 to be assembled, namely the pivoting support 3 in FIGS. 2 and 3. Thus, the link presents a protrusion 5 facing toward the interior 7 of the vehicle. This protrusion 5 therefore has a better quality appearance, notably thanks to the self-punching technique described hereinabove, used to produce the riveted links.

Moreover, such a self-punching technique presents the main advantage of obtaining a highly resistant and perfectly watertight assembly. It also makes it possible to be able to assemble parts made of different materials and of different thicknesses, while ensuring a high assembly resistance and no deterioration of the parts. Such a self-punching technique also offers the possibility of a simple visual inspection to check the assembly and a reproducible and reliable assembly quality.

FIG. 4 illustrates an arrangement of the riveted links which can be used to distribute the stresses and so contribute to improving the mechanical strength. Depending on the hinge 4 selected, the number of riveted links will be adjusted. For example, three riveted self-punched links have been produced in FIG. 4. The protrusions 5 formed by the rivets 10 are not aligned.

The materials used can, for example, be steel or aluminum. The parts 1, 2, 3 can, for example, be all made of aluminum or either made of aluminum or made of steel. The materials of the different parts 1, 2, 3 are not necessarily selected to be identical.

The selected arrangements therefore make it possible to ensure a better mechanical strength (peel, tear and shear) between the hinge 4 and the trunk lid 8. At least two riveted links are produced to ensure these results.

The inventive method is very simple to implement and provides a way of reducing operating times.

The advantages associated with simplicity and speed of implementation of such a method provide a way of reducing the costs incurred by the attachment operations and ensuring a better resistance of the link to corrosion.

Furthermore, this method is safe and substantially limits the risk of failure of an attachment of a hinge 4.

The teachings of this invention are obviously applicable to each of the many hinges that a vehicle could have to handle the opening or closing of a door leaf, such as the door, bonnet and other hinges.

1. A system for fixing a hinge on a door leaf of a motor vehicle, comprising:
at least two riveted self-punched links that clamp the hinge and the door leaf.

2. The fixing system as claimed in claim 1, wherein the door leaf is a trunk lid.

3. The fixing system as claimed in claim 2, wherein the riveted self-punched links clamp three stacked elements, a pivoting support for the hinge, a liner for the trunk lid and a reinforcing piece for the trunk lid.

4. A method of attaching a hinge on a door leaf of a motor vehicle, the hinge comprising:
a pivoting support, the door leaf comprising at least two elements, wherein:
the pivoting support, the first element and the second element of the door leaf, in that order, are stacked on a preformed support structure,
at least two riveted self-punched links are implemented on the second element so as to clamp the pivoting support and the two elements.

5. The method as claimed in claim 4, wherein the door leaf is a trunk lid comprising a liner, a reinforcing piece and wherein:
the hinge, the liner and the reinforcing piece, in that order, are stacked on a preformed support structure,
at least two riveted self-punched links are implemented on the reinforcing piece so as to clamp the pivoting support, the liner and the reinforcing piece.

6. The method as claimed in claim 5, wherein three non-aligned riveted self-punched links are implemented.
